(19) United States
(12) Patent Application Publication
(10) Pub. No.: US 2009/0136332 A1
(43) Pub. Date: May 28, 2009

(54) Hydraulic Apparatus

(76) Inventor: MARSHALL BOATES, Brentwood, TN (US)

Correspondence Address: ADVANTIA LAW GROUP, 9035 SOUTH 1300 EAST, SUITE 200, SANDY, UT, 84094, US

(21) Appl. No.: 12/324,822

(22) Filed: Nov. 26, 2008

Related U.S. Application Data
(60) Provisional application No. 61/004,570, filed on Nov. 28, 2007.

(51) Int. Cl. B60P 3/12

(52) U.S. Cl. 414/563; 414/812

(57) ABSTRACT

A hydraulic apparatus disposed about a rear end of a towing vehicle; wherein the apparatus includes an extendable double beam. The extendable double beam is configured to articulate when coupling to a towed vehicle. The apparatus includes a hydraulically sliding saddle coupled to the double beam. The apparatus includes a downward telescoping mast having a coupling device disposed near an end. The downward telescoping mast includes a universal point of attachment configured to couple to wheels of the towed vehicle. In addition, the apparatus includes a plurality of powered wire ropes and a plurality of support straps configured to secure and support the wheels of the towed vehicle. The apparatus includes a hydraulic power lift coupled to the beam. The towing vehicle includes a point of load bearing that is about between four feet to seven feet from the tandem axle trunnion of the tow truck.

### CROSS-REFERENCE TO RELATED APPLICATIONS

This invention claims priority, under 35 U.S.C. §120, to the U.S. Provisional Patent Application No. 61/004,570 to Boates filed on Nov. 28, 2007, which is incorporated by reference herein.

### FIELD OF THE INVENTION

The present invention relates to hydraulic apparatuses, specifically to a hydraulic apparatus disposed about a rear end of a towing vehicle, configured to tow and transport vehicles.

### DESCRIPTION OF THE RELATED ART

Conventional towing devices lift and pull a vehicle by hooking a chain or sling to the vehicles bumper, axle, or undercarriage. These conventional towing devices have proven to be inadequate for towing newer vehicles having light weight metal or plastic bodies which are easily damaged when pressure is exerted there against by the towing vehicle. An alternative method of towing a vehicle raises the vehicle by supporting the front or rear wheels off the ground by a mechanism engaging mainly only the wheels of the vehicle. Many of these wheel supporting mechanisms are constructed of relatively thick steel, making the towing vehicle heavy. This heavy weight is a concern to a towing vehicle because, the load on the rear of the towing truck is too heavy, then the front wheels of the towing vehicle will have a difficult time contacting the surface, in addition to having poor control of the towing vehicle while towing the disabled vehicle. Furthermore, with increasing loads and overall weight of heavy duty towing vehicles exceeding safety driving regulations, what is needed is a tow truck that is specialized to transport a variety of vehicles without exceeding safety driving regulations. Some improvements have been made in the field. Examples of references related to the present invention are described below, and the supported teachings of each reference are incorporated by reference herein:

U.S. Pat. No. 4,573,857, issued to Porter Sr., discloses a vehicle towing mechanism adapted to be utilized in conjunction with a truck for towing a wheeled vehicle. The towing mechanism includes an elongate main support member which is pivotally connected to the truck and extends rearwardly therefrom. The main support member has vertical, spaced side walls formed of a prestressed high tensile metal and is constructed to have an upwardly bowed configuration; such configuration is retained by an upper wall fixedly attached thereto. A vertical riser member is adapted to be vertically slidable relative to the truck rear end and is connected to the main support member to inhibit lateral movement. The main support member is connected to an apparatus which supports laterally spaced wheels of the vehicle and includes wheel-engaging devices for each wheel. Each device has a rotating section and a fixed section. Wheel retainers are adapted to secure the wheels within respective devices and securely lock the wheel-supporting apparatus in a selectively fixed position. A support cable is adapted to be operatively connected to a tow truck winch and to the main support member such that the vehicle towing mechanism and the vehicle to be towed are simultaneously lifted upon operation of the truck winch.

U.S. Pat. No. 5,435,586, issued to Smith, discloses a gooseneck and tow-hitch attachment includes a gooseneck, a sliding turntable plate assembly, a tow-hitch lifting assembly, a grab hook and a tow-hitch assembly. The sliding plate turntable assembly permits extension or retraction of the gooseneck and swivelable rotation thereof for towing trailers such as low bed trailers. The tow-hitch assembly and tow lifting frame assembly permit using the gooseneck and tow-hitch assembly in a tow truck mode. The tow-hitch assembly also provides a locking function to secure a low bed trailer or like in the gooseneck hitch while providing a lifting force to permit towing thereof. The grab hook functions to properly seat a trailer hitch equipment in the gooseneck and secure the trailer hitch for towing purposes.

U.S. Pat. No. 4,874,285, issued to Bubik, discloses a vehicle lifting and towing device and particularly to an improved low profile lifting and towing device capable of efficient placement of the lower lifting boom while providing added ballast against the tipping moment of the towing vehicle, as well as a column configuration permitting the upper boom to be generally horizontal providing improved driver vision from the cab of the towing vehicle.

U.S. Pat. No. 4,557,496, issued to Sill, discloses a vehicle lift device which may be easily attached to an ordinary truck for use in towing disabled vehicles. The lift device includes a frame which is secured to the truck, a telescoping beam pivotally mounted adjacent one end to the framework, and piston means secured between the framework and the beam one end for shifting the beam between a raised and lowered position. A crossbar is mounted at the other end of the beam and includes grids mounted thereon for receiving the wheels of the disabled vehicle.

U.S. Pat. No. 4,775,285, issued to Zackovich, discloses an elongated upright motor extendible and retractable support member is provided including relatively extendible upper and lower end sections and the upper end section is pivotally mounted from a rear upper portion of body of a tow truck for oscillation relative thereto about a first horizontal axis extending transversely of the chassis and the upper end section. The support member is swingable between a generally vertical lowered position and a raised inclined position with the lower end section swung outwardly and upwardly from the vehicle rear end and a motor extendible and retractable light and tow arm having relatively extendible front and rear ends as provided and the front end is mounted from the lower end section of the support member for oscillation relative thereto about a second horizontal axis extending transversely of the arm and the lower end section. The arm is swingable between a lowered position with the arm disposed generally 90.degree. relative to the support member and projecting rearwardly therefrom and a raised position closely parallel the rear side of the support member. The rear end of the arm has a cross beam oscillatably supported therefrom and the opposite ends of the beam include structure for cradling the underside peripheral portions of the opposite side wheels of the vehicle to be towed. Further, motor structure is connected between the vehicle chassis and the upper end section of the support member for adjustably swinging the latter between the raised and lowered positions thereof.

U.S. Pat. No. 4,927,315, issued to Nespor, discloses a wheel lift type vehicle lifting and towing device which includes an extendible and tiltable boom having three telescoping sections for extension from the rear of a towing vehicle and means for raising and lowering the boom. The boom is extended and retracted by a pair of hydraulic cylinders mounted within the first and second boom sections. Another pair of hydraulic cylinders are pivotally mounted to the towing vehicle within the understructure thereof and the boom to tilt the boom. The means for raising and lowering, for extending and retracting and for tilting the boom all may be operated independently of each other. When the apparatus is in a storage position, it is retracted substantially out of view within the understructure of the body of the towing vehicle.

The inventions heretofore known suffer from a number of disadvantages which include being limited in application, being limited in versatility, being expensive, being unduly complex, being limited in adaptability, being over weight, exceeding safety driving regulations, being unsafe, being cumbersome to use, being damaging, and being limited in the weight that can be towed.

What is needed is a hydraulic apparatus that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available hydraulic apparatuses on towing vehicles. Accordingly, the present invention has been developed to provide a safe, legal, and efficient device to transport vehicles.

In one embodiment of the invention, there is a hydraulic apparatus disposed about a rear end of a towing vehicle configured to tow vehicles; wherein the apparatus may include an extendable double beam disposed about the rear of the towing vehicle. The extendable double beam may be configured to articulate when coupling to a towed vehicle. The apparatus may also include a hydraulically sliding saddle coupled to the double beam and configured to receive wheels of a towed vehicle.

In addition, the apparatus may include a downward telescoping mast having a coupling device disposed near an end of the mast and configured to couple the end of the mast to an underside of the towed vehicle. The coupling device may attach to the cross-members of a frame of a towed vehicle. The coupling device may also include a pair of hooks configured to couple to the cross-members of a frame of a towed vehicle. The downward telescoping mast may include a universal point of attachment configured to couple to wheels of the towed vehicle. The downward telescoping mast may further include a roller disposed about an end of the mast, configured to transport the mast on the ground along the centerline of the towed vehicle while preparing to tow.

The apparatus may further include a plurality of powered wire ropes coupled to the sliding saddle and configured to couple to the wheels of the towed vehicle. Furthermore, the apparatus may include a plurality of support straps coupled to the apparatus, the sliding saddle, and the telescoping mast; wherein the plurality of support straps are configured to secure and support the wheels of the towed vehicle. The apparatus may also include a hydraulic power lift coupled to the beam and the sliding saddle; wherein the power lift is configured to lift the towed vehicle. The apparatus may be coupled to the towed vehicle at a point of load bearing that is about between four feet to seven feet from the tandem axle trunnion of the tow truck. The apparatus may be coupled to the rear of the towing vehicle, wherein the towing vehicle may include a twenty-five to fifty percent shorter wheel base than a conventional tow truck wrecker. In addition, the apparatus may include an axle member having an axle and wheels and disposed about an end of the downward telescoping mast configured to be used when towing a vehicle with no frame.

In one embodiment of the invention, there is a method of attaching a vehicle to a towing vehicle; wherein the method may include positioning the tow truck about either end of the towed vehicle, preferably about the centerline. The method may also include lowering the extendable double beam and the downward telescoping mast in front of the vehicle to be towed. Then, the method may include positioning the beam and mast along the centerline of the vehicle, between the tires and the ground until the saddle meets the tires. In addition, the method may include extending the double beam underneath the towed vehicles centerline. The method then may include sliding the saddle underneath the wheels. Furthermore, the method may include coupling the wheels to the saddle with the plurality of powered wired ropes. The method may further include coupling the coupling device to the cross-members of a frame that are oppositely disposed from the centerline. Additionally, the method may include coupling the plurality of support straps to the coupling device and the saddle. Further, the method includes tightening the plurality of powered wire ropes and the plurality of support straps, thereby securing the towed vehicle. Finally, the method includes lifting the towed vehicle above the ground to tow the vehicle to a desired location.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a side elevational view of a hydraulic apparatus disposed about a rear end of a towing vehicle, according to one embodiment of the invention;

FIG. 2 is a rear elevational view of a hydraulic apparatus disposed about a rear end of a towing vehicle, according to one embodiment of the invention; and

FIG. 3 is a side elevational view of a hydraulic apparatus disposed about a rear end of a towing vehicle coupled to a vehicle, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

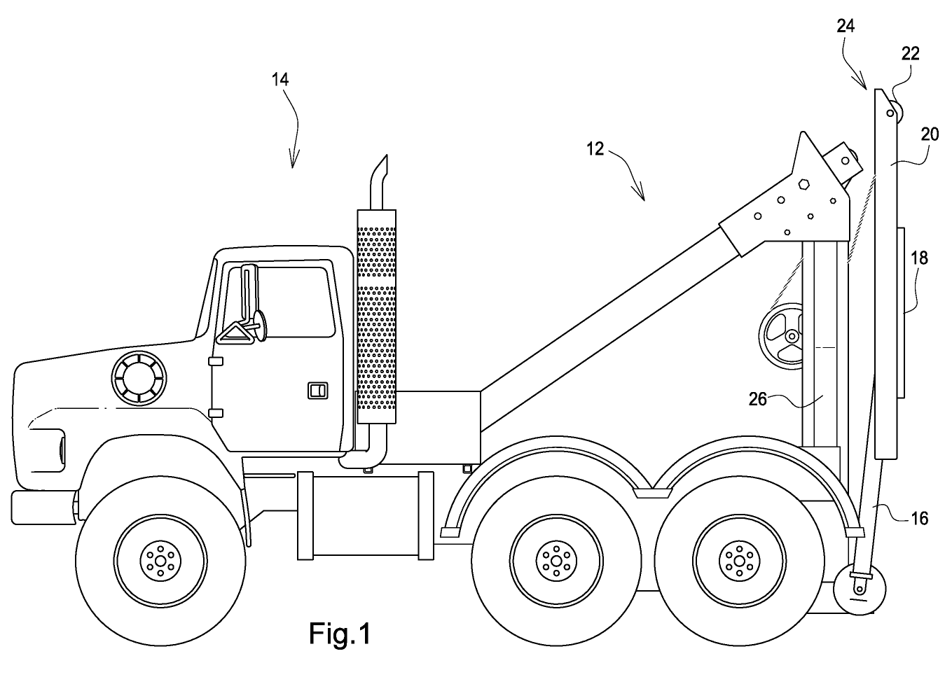

FIG. 1 illustrates a side elevational view of a hydraulic apparatus disposed about a rear end 12 of a towing vehicle 14, according to one embodiment of the invention, wherein the hydraulic apparatus includes an extendable double beam 16 disposed about the rear end 12 of the towing vehicle 14. The apparatus also includes a hydraulically sliding saddle 18 coupled to the double beam 16 and configured to receive wheels of a towed vehicle. In addition, the apparatus includes a downward telescoping mast 20. The downward telescoping mast 20 includes a roller 22 disposed about an end 24 of the mast 20 configured to transport the mast 20 along the centerline of the towed vehicle. Furthermore, the apparatus includes a hydraulic power lift 26 coupled to the beam 16 and the sliding saddle 20; wherein the power lift 26 is configured to raise the towed vehicle. The apparatus is coupled to the rear 12 of the towing vehicle 14, wherein the towing vehicle 14 includes a twenty-five to fifty percent shorter wheel base than a conventional tow truck wrecker.

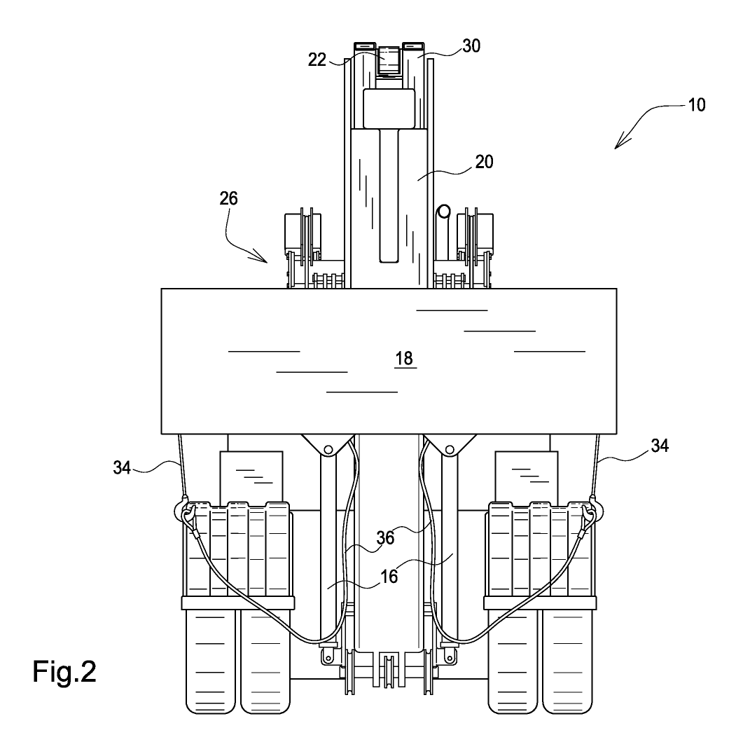

FIG. 2 is a rear elevational view of a hydraulic apparatus 10 disposed about a rear end of a towing vehicle, according to one embodiment of the invention, wherein the hydraulic apparatus 10 includes an extendable double beam 16 disposed about the rear of the towing vehicle. The apparatus 10 also includes a hydraulically sliding saddle 18 coupled to the double beam 16 and configured to receive wheels of a towed vehicle. In addition, the apparatus 10 includes a downward telescoping mast 20 having a coupling device 30 disposed near an end of the mast 20 and configured to couple the end of the mast 20 to an underside of the towed vehicle. The coupling device 30 attaches to the cross-members of a frame of a towed vehicle. The downward telescoping mast 20 further includes a roller 22 disposed about an end of the mast 20 configured to transport the mast 20 along the centerline of the towed vehicle.

The apparatus 10 further includes a plurality of powered wire ropes 34 coupled to the sliding saddle 18 and configured to couple to the wheels of the towed vehicle. Furthermore, the apparatus 10 included a plurality of support straps 36 coupled to the apparatus 10, the sliding saddle 18, and the telescoping mast 20; wherein the plurality of support straps 36 are configured to secure and support the wheels of the towed vehicle. The apparatus 10 also includes a hydraulic power lift 26 coupled to the beam 16 and the sliding saddle 18; wherein the power lift 26 is configured to lift the towed vehicle.

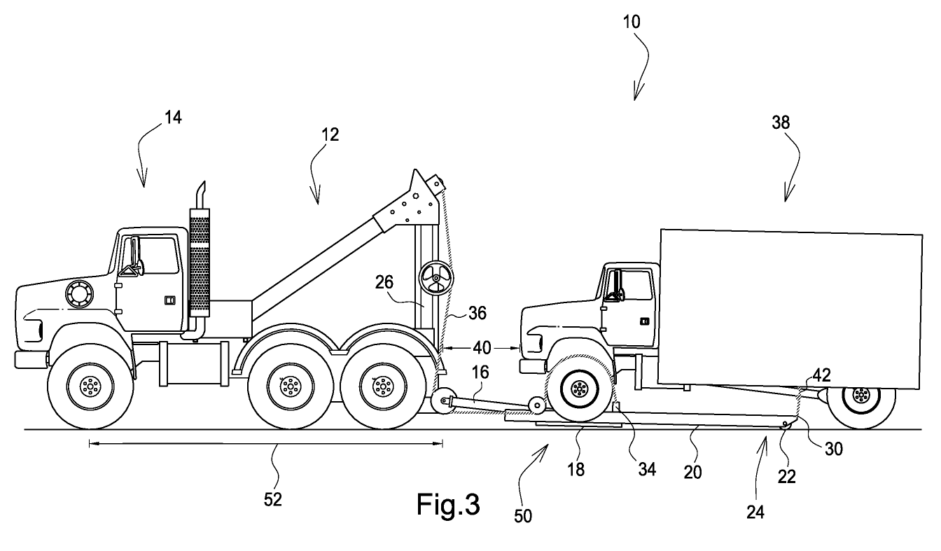

FIG. 3 is a side elevational view of a hydraulic apparatus 10 disposed about a rear end 12 of a towing vehicle 14 about to raise a vehicle to be towed 38, according to one embodiment of the invention, wherein the hydraulic apparatus 10 includes an extendable double beam 16 disposed about the rear 12 of the towing vehicle 14. The extendable double beam 16 is configured to articulate when coupling to a towed vehicle 38. When lowering the beam 16, the beam 16 may sway from side to side, thereby becoming a hazard to the operator and others; the extended beam 16 is configured articulate, wherein the beam 16 is being stabilized by the plurality of support straps 36. The apparatus 10 also includes a hydraulically sliding saddle 18 coupled to the double beam 16 and configured to receive wheels of the towed vehicle 38.

In addition, the apparatus 10 includes a downward telescoping mast 20 having a coupling device 30 disposed near an end of the mast 24 and configured to couple the end of the mast 24 to an underside of the towed vehicle 38. The coupling device attaches to the cross-members of a frame of the towed vehicle 38. The coupling device 30 also includes a pair of hooks 42 configured to couple to the cross-members of a frame of the towed vehicle 38. The downward telescoping mast 20 includes a universal point of attachment 50 configured to couple to either axle of the towed vehicle 38. The downward telescoping mast 20 further includes a roller 22 disposed about an end 24 of the mast 20 configured to transport the mast 20 along the centerline of the towed vehicles 38.

The apparatus 10 further included a plurality of powered wire ropes 34 coupled to the sliding saddle 18 and configured to couple to the wheels of the towed vehicle 38. Furthermore, the apparatus 10 included a plurality of support straps 36 coupled to the apparatus 10, the sliding saddle 18, and the telescoping mast 20; wherein the plurality of support straps 36 are configured to secure and support the wheels of the towed vehicle 38. The apparatus 10 also includes a hydraulic power lift 26 coupled to the beam 16 and the sliding saddle 18; wherein the power lift 26 is configured to lift the towed vehicle 38. The apparatus 10 is coupled to the towed vehicle 38 at a point of load bearing 40 that is about between four feet to seven feet from the tandem axle trunnion of the tow truck 14. The apparatus 10 is coupled to the rear 12 of the towing vehicle 14; wherein the towing vehicle 14 includes a twenty-five to fifty percent shorter wheel base 52 than a conventional tow truck wrecker.

In operation of one embodiment of the invention, a tow truck operator positions the tow truck 14 about either end of the towed vehicle 38, preferably about the centerline. The operator then lowers the extendable double beam 16 and the downward telescoping mast 20 in front of the vehicle to be towed 38. Then, the operator positions the beam 16 and mast 20 along the centerline of the towed vehicle 38, between the tires and the ground until the saddle meets the tires. Then, the operator extends the double beam 16 underneath the towed vehicles centerline. The operator then slides the saddle 18 underneath the wheels of the towed vehicle. Furthermore, the operator couples the wheels to the saddle 18 with the plurality of powered wired ropes 34. Then, the operator couples the coupling device 30 to the cross-members of a frame that are oppositely disposed from the centerline of the towed vehicle. Additionally, the operator couples the plurality of support straps 36 to the coupling device 30 and the saddle 18. Further, the operator tightens the plurality of powered wire ropes 34 and the plurality of support straps 36, thereby securing the towed vehicle 38 to the apparatus 10. Finally, the operator lifts the towed vehicle 38 above the ground to tow the vehicle to a desired location.

The invention is intended to solve the problem of overweight and unsafe tow truck wreckers. Seventy-five percent of the time a tow truck operator spends driving the disabled vehicle to the desired location, only rarely does an operator use a recovery system attached to the tow truck. But typically, a tow truck is equipped with a recovery system along with the conventional towing apparatus. The recovery system adds an extra ten thousand pounds, usually making the total tandem axle weight of a tow truck around twenty-four thousand pounds.

The legal limit is typically thirty four thousand pounds at the tandem axles, between the wrecker and the towed vehicle. That means the added weight from the towed vehicle cannot exceed approximately ten thousand pounds to be under the legal limit. Typically, a wrecker tows the vehicle between ten and fourteen feet behind the wrecker, thereby adding an additional leverage weight to the load bearing axle of the wrecker.

The Applicant's design eliminates a recovery system and adjusts the attachment of the towed vehicle to minimize leverage weight. This lowers the tandem axle weight of the wrecker. Accordingly, such a wrecker will be able to tow vehicles having a much greater total weight while still complying to legal limits and regulations. In addition, when making a lighter wrecker and minimizing the leverage weight about the load bearing axle, the wrecker is more stable. By minimizing the leverage weight on the load bearing axle the steering axle maintains more of its existing weight and therefore ground contact, thereby making transporting the disabled vehicle safer.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a plurality of powered wired ropes 34 and a plurality of support straps 36, one skilled in the art would appreciate that the wired ropes and support straps may vary in size, shape, length, strength, diameter, number and still perform its intended function. In addition, the support straps are configured to be disposed within the telescoping mast and still perform its intended function.

Additionally, although the figures illustrate a tandem axle trunnion tow truck, one skilled in the art would appreciate that the tow truck may vary in size, shape, design, configuration, and still perform its intended function. A non-limiting example is a tri-axle trunnion tow truck.

It is also envisioned that the towing vehicle may include an axle member disposed about an end of the downward telescoping mast configured to be used when towing a vehicle with no frame. The axle member includes an axle assembled thereto and wheels configured to hold the end of the mast off the ground.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A hydraulic apparatus disposed about a rear end of a towing vehicle, configured to tow vehicles, comprising:
a) an extendable double beam disposed about the rear of the towing vehicle;
b) a hydraulically sliding saddle coupled to the double beam and configured to receive wheels of a towed vehicle;
c) a downward telescoping mast having a coupling device disposed near an end of the mast and configured to couple the end of the mast to an underside of the towed vehicle;
d) a plurality of powered wire ropes coupled to the sliding saddle and configured to couple to the wheels of the towed vehicle;
e) a plurality of support straps coupled to the apparatus, the sliding saddle, and the mast; wherein the support straps are configured to secure and support the towed vehicle; and
f) a hydraulic power lift coupled to the beam and configured to lift the towed vehicle.

2. The apparatus of claim 1, wherein the apparatus is coupled to the towing vehicle at a point of load bearing that is about between four feet to seven feet from the tandem axle trunnion of the tow truck.

3. The apparatus of claim 1, wherein the towing vehicle includes a twenty-five to fifty percent shorter wheel base than a conventional tow truck.

4. The apparatus of claim 1, wherein the downward telescoping mast includes a universal point of attachment configured to couple to wheels of the towed vehicle.

5. The apparatus of claim 1, wherein the hydraulic apparatus further includes an axle member having an axle and wheels and disposed about an end of the downward telescoping mast configured to be used when towing a vehicle with no frame.

6. The apparatus of claim 1, wherein the downward telescoping mast further includes a roller disposed about an end of the mast configured to transport the mast on the ground along the centerline of the vehicle to be towed while preparing to tow.

7. The apparatus of claim 1, wherein the coupling device attaches to the cross-members of a frame of a towed vehicle.

8. The apparatus of claim 1, wherein the extendable double beam is configured to articulate when coupling and transporting a towed vehicle.

9. The apparatus of claim 1, wherein the coupling device further includes a pair of hooks configured to couple to the cross-members of a frame of a towed vehicle.

10. A towing vehicle having a hydraulic apparatus disposed about a rear end of a towing vehicle, configured to tow vehicles, comprising:
a) an extendable double beam disposed about the rear of the towing vehicle;
b) a hydraulically sliding saddle coupled to the double beam and configured to receive wheels of a towed vehicle;
c) a downward telescoping mast having a coupling device disposed near an end of the mast and configured to couple the end of the mast to an underside of the towed vehicle;
d) a plurality of powered wire ropes coupled to the sliding saddle and configured to couple to the wheels of the towed vehicle;
e) a plurality of support straps coupled to the apparatus, the sliding saddle, and the mast; wherein the support straps are configured to secure and support the towed vehicle; and
f) a hydraulic power lift coupled to the beam and configured to lift the towed vehicle.

11. The vehicle of claim 10, wherein the apparatus is coupled to the towed vehicle at a point of load bearing that is about between four feet to seven feet from the tandem axle trunnion of the tow truck.

12. The vehicle of claim 11, wherein the towing vehicle includes a twenty-five to fifty percent shorter wheel base than a conventional tow truck.

13. The vehicle of claim 12, wherein the downward telescoping mast includes a universal point of attachment configured to couple to wheels of the towed vehicle.

14. The vehicle of claim 13, wherein the hydraulic apparatus further includes an axle member having an axle and wheels and disposed about an end of the downward telescoping mast configured to be used when towing a vehicle with no frame.

15. The vehicle of claim 14, wherein the downward telescoping mast further includes a roller disposed about an end of the mast configured to transport the mast on the ground along the centerline of a vehicle to be towed while preparing to tow.

16. The vehicle of claim 15, wherein the coupling device attaches to the cross-members of a frame of a towed vehicle.

17. The vehicle of claim 16, wherein the extendable double beam is configured to articulate when coupling and transporting a towed vehicle.

18. The vehicle of claim 17, wherein the coupling device further includes a pair of hooks configured to couple to the cross-members of a frame of a towed vehicle.

19. The method of attaching a vehicle to a towing vehicle, comprising:
a) positioning the tow truck about either end of the towed vehicle, preferably about the centerline;
b) lowering the extendable double beam and the downward telescoping mast in front of the vehicle to be towed;
c) positioning the beam and mast along the centerline of the vehicle, between the tires and the ground until the saddle meets the tires;
d) extending the double beam underneath the centerline of the vehicle to be towed;
e) sliding the saddle underneath the wheels;
f) coupling the wheels to the saddle with the plurality of powered wired ropes;
g) coupling the coupling device to the cross-members of a frame that are oppositely disposed from the centerline;
h) coupling the plurality of support straps to the coupling device and the saddle;
i) tightening the plurality of powered wire ropes and the plurality of support straps, thereby securing the towed vehicle; and
j) lifting the towed vehicle above the ground to tow the vehicle to a desired location.
